(19) United States
(12) Patent Application Publication
(10) Pub. No.: US 2011/0145857 A1
(43) Pub. Date: Jun. 16, 2011

(54) SCALABLE ADVERTISING SYSTEM FOR DYNAMICALLY INSERTING ADVERTISEMENTS

(75) Inventors: Gaurav Agarwal, San Francisco, CA (US); Benjamin Karl Harden, Frisco, TX (US); Patricia L. Dunbar, San Francisco, CA (US); Pradip Kumar Fatehpuria, San Jose, CA (US)

(73) Assignee: MICROSOFT CORPORATION, Redmond, WA (US)

(21) Appl. No.: 12/639,940

(22) Filed: Dec. 16, 2009

(51) Int. Cl. H04N 7/10

(52) U.S. Cl. 725/32

(57) ABSTRACT

An advertising client device for inserting an advertisement into a live video programming stream is provided. One embodiment of the advertising client device comprises a match engine executed on a processor of the advertising client device. The match engine is configured to receive a programming stream from a media server upon tuning to the programming stream, to send an advertising decision request, after a predetermined delay time after tuning to the programming stream, to an advertising decision server for one or more advertising decisions for a predetermined programming time block, to receive an advertising decision response from the advertising decision server, to insert an advertisement into the programming stream based on a match between an in-band marker included in the programming stream and the advertising decision response, and to send the programming stream including the advertisement to a display for viewing.

### BACKGROUND

Live video programs include advertising avails into which advertisers may insert advertisements for presentation to viewers. Some advertisements are shown to a national audience, while others are shown to a regional audience. National advertisements are typically inserted by a national content provider, such as a cable network, while regional advertisements are typically inserted by a network service provider. Some national advertisements may be overridden by a local advertisement based on agreements between the national content provider and the network service provider. To achieve this, an avail may be filled with an optional national advertisement by the national content provider, which is to be shown in the event a regional advertisement is not inserted by a downstream local cable network operator.

Recently, set top boxes and other client side devices have been proposed that can insert an advertisement into a program at an avail. Such devices may have limited scalability, and may involve a substantial capital and operational expenditures to manage such end-to-end systems. Another drawback with such an approach is that if a user tunes to a program during an avail, the set top box may miss an advertising opportunity, or the set top box may be unaware that an underlying national advertisement is being presented and may interrupt the national advertisement to present an advertisement selected by the set top box. Such unpleasant viewing experiences may result in delayed adoption of narrowcast advertising and the attendant benefits thereof.

### SUMMARY

An advertising client device for inserting an advertisement into a live video programming stream is provided. One embodiment of the advertising client device comprises a match engine executed on a processor of the advertising client device. The match engine is configured to receive a programming stream from a media server upon tuning to the programming stream, to send an advertising decision request, after a predetermined delay time after tuning to the programming stream, to an advertising decision server for one or more advertising decisions for a predetermined programming time block, to receive an advertising decision response from the advertising decision server, to insert an advertisement into the programming stream based on a match between an in-band marker included in the programming stream and the advertising decision response, and to send the programming stream including the advertisement to a display for viewing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an embodiment of an advertising media system for inserting an advertisement into a live video programming stream.

FIG. 2 is a schematic view of an embodiment of a method for insertion of an advertisement into a live video programming stream.

### DETAILED DESCRIPTION

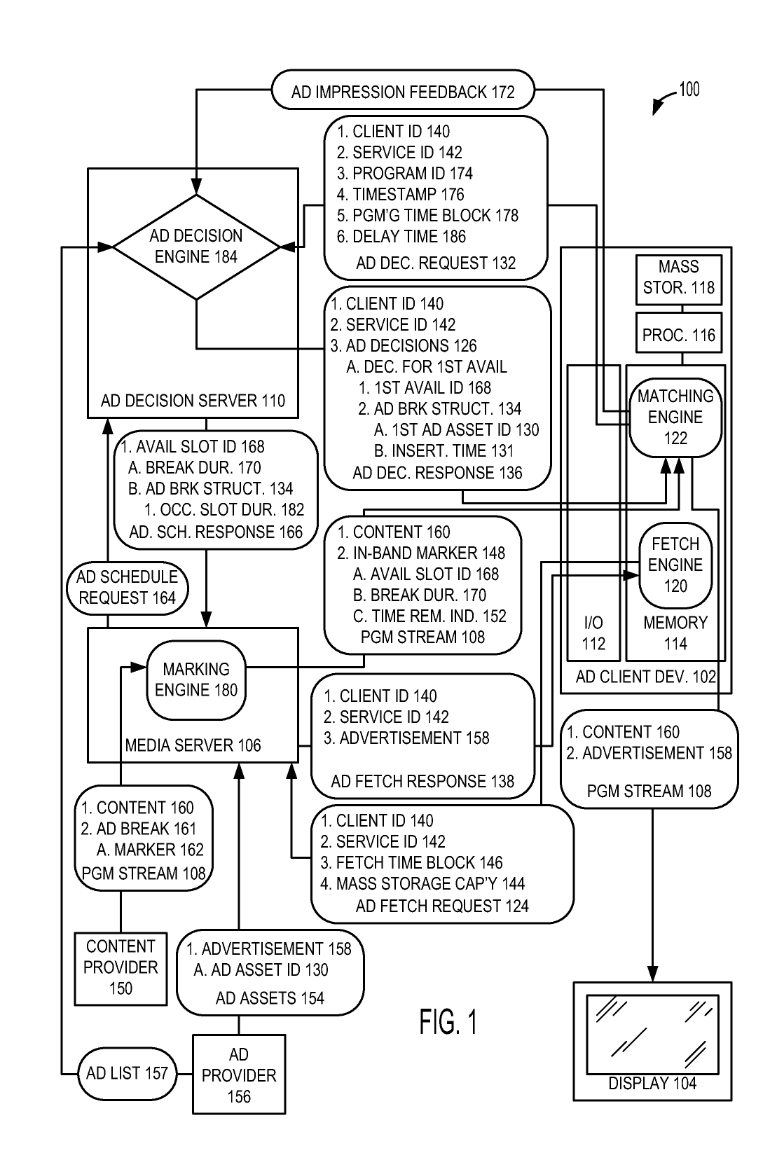

FIG. 1 shows an advertising media system 100, including an advertising client device 102 for inserting an advertisement into a programming stream 108 for display on a display 104. It will be appreciated that display 104 may have the form of a suitable display for displaying live video programming content from a content provider, and may or may not include an internal tuner configured to receive digital or analog programming streams delivered over the air, over a cable, over an internet connection, etc. Advertising media system 100 may perform tasks associated with advertisement insertion in three phases, namely, an advertisement fetch phase, a scheduling phase, and an insertion phase, as explained in detail below. It will be appreciated that these phases are for clarity of presentation of the illustrated embodiment, and that in other embodiments, tasks maybe organized into other suitable phases, and other suitable orders of tasks may be employed. By way of introduction, these phases will now be described at an overview level, prior to turning to the detailed operations of each phase of the system.

During the advertisement fetch phase of operation, advertising media system 100 may be configured to receive advertisements for contemporaneous or later display. For example, advertising client device 102 may be configured to receive an advertisement 158 for insertion into programming stream 108 from media server 106 in response to an advertisement fetch request 124. It will be appreciated that some embodiments of advertising client device 102 may be configured to receive advertisements from sources other than media server 106. For example, in a first scenario, advertising client device 102 may receive advertisements from servers operating in a network cloud environment, while in a second scenario, advertising client device 102 may be configured to receive advertisements streamed as a unicast transmission or a multicast transmission from an advertising provider 156.

During the scheduling phase of operation, advertising media system 100 may be configured to schedule advertising for display on display 104. For example, media server 106 may be configured to receive an advertising schedule response 166 from an advertising decision server 110 for identifying a schedule of available advertising slots in programming stream 108 in response to an advertisement schedule request 164.

During the insertion phase of operation, advertising media system 100 may be configured to insert advertisements into programming stream 108 for display on display 104. In the insertion phase, programming stream 108, which originates at a content provider 150 and includes content 160, may be modified by media server 106 to include an in-band marker 148 according to an advertising schedule response 166. Programming stream 108 may be served subsequently to advertising client device 102. Upon tuning to programming stream 108, advertising client device 102 may be configured to receive an advertising decision response 136 including one or more advertising decisions 126 for advertisement 158 from advertising decision server 110 and to receive programming stream 108 from media server 106. Additionally, advertising client device 102 may be configured to insert advertisement 158 into programming stream 108 based on advertising decision response 136 and in-band marker 148 and to display programming stream 108 including advertisement 158 on display 104.

Turning now to the details by which advertising client device 102 requests and receives advertisement 158 during the advertisement fetch phase of operation, advertising client device 102 may comprise a fetch engine 120 for fetching advertisement 158. Fetch engine 120 may be stored in mass storage 118 of advertising client device 102, and may be loaded into memory 114 for execution by processor 116.

Fetch engine 120 may be configured to send an advertisement fetch request 124 to media server 106. Advertisement fetch request 124 may be configured to prompt media server 106 to send advertisement 158 to advertising client device 102. In some embodiments, advertisement fetch request 124 may be configured to request a plurality of advertisements 158 for insertion during a predetermined fetch time block 146. For example, if fetch time block 146 is a twenty-four hour block of time subsequent to receipt of advertisement fetch request 124, media server 106 may send a plurality of advertisements 158 for insertion during the subsequent twenty-four hour period.

In some embodiments, advertising fetch request 124 may include identifier data about advertising client device 102. For example, a client identifier 140 configured to identify advertising client device 102 may be included, as may a service identifier 142 configured to identify content provider 150 of programming stream 108.

Advertising fetch request 124 may also include a mass storage capacity value 144 representing a mass storage capacity of advertising client device 102. For example, if mass storage 118 is a hard disk, a remaining hard disk capacity value may be included in advertising fetch request 124 for providing information to media server 106 about how much hard disk capacity remains on advertising client device 102.

Continuing with the details of the advertisement fetch phase, advertising media system 100 also may include media server 106, which may be configured to receive one or more advertisement assets 154 from advertising provider 156, which may be a suitable provider of advertisement assets 154 such as a manufacturer or an advertising network. For example, advertisement asset 154 may be a snowboard advertisement provided by a snowboard manufacturer. It will further be appreciated that in some embodiments advertisement 158 may be fetched from a server operating in a network cloud environment, and that the server may communicate the advertisement 158 via a streaming unicast transmission or a multicast transmission, for example.

In some embodiments, upon receiving advertisement fetch request 124 from advertising client device 102, media server 106 may be configured to send an advertising fetch response 138 to advertising client device 102. Advertising fetch response 138 may be configured to include advertisement 158. In some embodiments, advertising fetch response 138 may be configured to include a plurality of advertisements for insertion during fetch time block 146. Advertising fetch response 138 may also include client identifier 140 and service identifier 142.

Optionally, advertising client device 102 may store advertisement 158 upon receipt of advertising fetch response 138 for later insertion into programming stream 108. Thus, for example, advertising fetch response 138 may include the snowboard advertisement as well as other advertisements for storage and insertion into programming stream 108 at advertising client device 102.

Turning now to the details of the scheduling phase of operation, media server 106 may be configured to send advertising schedule request 164 to advertising decision server 110 for identifying a schedule of available advertising slots in a programming stream. Upon receipt of advertising schedule request 164, advertising decision server 110 may be configured to generate an advertising schedule for programming stream 108 for a configurable time block. For example, advertising decision server 110 may generate an advertising schedule for a twenty-four hour period. The advertising schedule may be sent to media server 106 as an advertising schedule response 166. In some embodiments, advertising schedule request 164 may be sent by media server 106 to advertising decision server 110 at configurable intervals. For example, media server 106 may send advertising schedule request 164 at sixty-minute intervals.

Advertising schedule response 166 may include a plurality of availability slot identifiers 168 associated with a plurality of corresponding advertising breaks 161 of programming stream 108. Each availability slot identifier 168 may identify an instance in programming stream 108 at which one or more advertisements 158 may be inserted. Additionally, each availability slot identifier 168 may be associated with a break duration 170 of advertising break 161.

In some embodiments, some advertisements may already have been inserted upstream of advertising client device 102. Thus, each availability slot identifier 168 may be associated with an advertising break structure 134 configured to represent an arrangement of occupied advertising slots and of advertising slots which are available for insertion of advertisements at advertisement client device 102. Further, advertising break structure 134 may include an occupied slot duration 182 corresponding to a duration of an occupied advertising slot.

Turning now to the details of the insertion phase of operation, which may be generally subdivided into a marking sub-phase and an insertion sub-phase for illustrating one embodiment of advertising media system 100. It will be appreciated that this breakdown into sub-phases is made for clarity of presentation, and that other suitable arrangements may be employed.

Turning first to the marking sub-phase, media server 106 may be configured to receive programming stream 108 from content provider 150, to modify programming stream 108 by insertion of an in-band marker 148, and to send programming stream 108 including in-band marker 148 to advertising client device 102 when advertising client device 102 is tuned to programming stream 108.

Programming stream 108 may include content 160. Content 160 may include entertainment content provided by content provider 150. Content 160 may also include advertising content provided by content provider 150. Additionally, programming stream 108 may include advertising break 161, a start of which may be signaled by an advertising break marker 162. Advertising break marker 162 may include a break marker format. For example, in some embodiments, advertising break marker 162 may be formatted according to a Society of Cable Telecommunications Engineers (SCTE) format, such as an SCTE 35 format. However, it will be appreciated that other suitable formats may also be employed.

Programming stream 108 may be modified by marking engine 180 of media server 106 according to advertising schedule response 166. For example, as advertising break markers 162 arrive at media server 106, marking engine 180 may insert in-band marker 148. In-band marker 148 may be configured to be recognized by match engine 122 of advertising client device 102 to facilitate insertion of advertisement 158 into programming stream 108.

In-band marker 148 may include availability slot identifier 168 and corresponding break duration 170. For example, media server 106 may receive an advertising break marker 162 six seconds before the start of advertising break 161. Marking engine 180 may subsequently insert in-band marker 148. In some embodiments, media server 106 may insert a time-remaining indicator 152 with in-band marker 148 for indicating a remaining time of break duration 170 and for keeping track of a time position in advertising break 161 at which advertising client device 102 was tuned to programming stream 108. Media server 106 may index time-remaining indicator 152 and re-insert in-band marker 148 into programming stream 108 at predetermined index time intervals to indicate to advertising client device 102 how much time remains in advertising break 161. For example, media server 106 may insert in-band marker 148 at fifteen-second intervals, indexing time-remaining indicator 152 at each insertion. Thus, advertising client device 102 may avoid inserting advertisement 158 in a scenario where there is insufficient remaining time in the break as determined by a comparison between time-remaining indicator 152 and a duration of advertisement 158. Having inserted in-band marker 148, media server 106 may send programming stream 108, including in-band marker 148 and content 160, to advertising client device 102 for the insertion sub-phase.

Turning now to the details of the insertion sub-phase, advertising client device 102 may include match engine 122 for inserting advertisement 158 into programming stream 108. Match engine 122, which may be stored in mass storage 118 of advertising client device 102 and may be loaded into memory 114 for execution by processor 116, may be configured to receive programming stream 108 from media server 106 upon tuning to the programming stream 108.

Additionally, match engine 122 may be configured to send an advertising decision request 132 to advertising decision server 110. Advertising decision request 132 may be configured to request one or more advertising decisions 126 for a predetermined programming time block 178. Advertising decision server 110 may make advertising decision 126 for each available advertising slot occurring within predetermined programming time block 178 at advertising decision engine 184. For example, for a sixty minute predetermined time block, advertising decision server 110 may make three advertising decisions for each of three available advertising slots.

Advertising decision engine 184 may use a heuristic approach based on parameters included within advertising decision request 132 to make each advertising decision 126. Advertising decision engine 184 may base advertising decision 126 on an advertisement list 157 received from advertising provider 156. In some embodiments, advertising decision engine 184 may base advertising decision 126 in part on client identifier 140, service identifier 142, program identifier 174, timestamp 176, and programming time block 178 received in advertising decision request 132. For example, in one scenario, advertising decision engine 184 may make a Tuesday morning advertising decision to show an advertisement for coffee during an early morning programming time block based on the content provider and programming stream that the subscriber is tuned to during the early morning time block.

Further, advertising decision 126 may be based in part on advertisement impression feedback 172 received from advertising client device 102. In some embodiments, advertisement impression feedback 172 may include a report of which advertisements have been inserted by advertising client device 102 within a predetermined viewing history. For example, if the subscriber has viewed the coffee advertisement several times, advertising decision engine 184 may decide to show a toaster pastry advertisement in a Wednesday morning advertising decision based in part on advertising impression feedback 172.

In some embodiments, advertisement impression feedback 172 may include a list of advertisements previously inserted, times at which the advertisements were inserted, times within individual available advertising slots at which specific advertisements were inserted, for how long each advertisement was displayed, etc. Further, in some embodiments, advertisement impression feedback 172 may include a report of a playback mode employed when advertisements were displayed. For example, advertisement impression feedback 172 may include a report of whether the advertisement was displayed during a fast forward, rewind, or normal playback modes. Further still, in some embodiments, advertisement impression feedback 172 may include a report listing reasons why display of an advertisement was incomplete. For example, the report may indicate whether advertising client device 102 was tuned to a different programming stream 108 during display of the advertisement, whether advertising client device 102 was restarted or rebooted, etc.

Additionally or alternatively, in some embodiments, advertising client device 102 may collect and cache advertisement impressions for inclusion in a later-transmitted advertisement impression feedback 172. For example, advertising client device 102 may cache each advertisement impression locally. In one scenario, the cached advertisement impressions may be later reported to advertising decision server 110 according to a predetermined transmission schedule. In another scenario, the transmission of advertisement impression feedback 172 may be made according to a network traffic load. For example, the later transmission may be made during a relative lull in network traffic according to a network traffic load.

Match engine 122 may be configured, in some embodiments, to delay sending advertising decision request 132 until after a predetermined delay time 186 after tuning to the programming stream 108 has elapsed. For example, match engine 122 may wait for the subscriber to linger at a winter sports program for 30 seconds before sending a winter sports program advertising decision request. This may reduce a number of advertising decision requests 132 as the subscriber selects a programming stream 108. Consequently, delaying sending advertising decision request 132 until after predetermined delay time 186 may reduce load on a network, at advertising decision server 110, at advertising client device 102, etc.

Additionally, match engine 122 may be configured to receive an advertising decision response 136 from advertising decision server 110. In some embodiments, advertising decision response 136 may be stored at advertising client device 102. For example, in the early morning programming scenario described above, Tuesday morning advertising decisions may be stored for the duration of the early morning programming time block on Tuesday morning. Further, in some embodiments, advertising decision response 136 may be stored at advertising client device 102 according to availability slot identifier 168 and/or service identifier 142 during predetermined programming time block 178 for later retrieval by advertising client device 102. Further still, in some embodiments, multiple advertising decision responses 136 may be stored at advertising client device 102 for multiple service identifiers 142 during corresponding predetermined programming time blocks 178 for each service identifier 142. For example, in one embodiment advertising decision responses 136 for up to four service identifiers 142 may be stored at advertising client device 102. Advertising decision response 136 may include one or more advertising decisions 126 for one or more available advertising slots corresponding to one or more advertising breaks 161.

Advertising decision 126 may be configured to include availability slot identifier 168 and advertising break structure 134. Further, each advertising decision 126 may include one or more advertisement asset identifiers 130 for identifying a respective advertisement 158. In some embodiments, advertisement 158 may be stored at advertising client device 102. However, it will be appreciated that advertisement 158 may be received from other suitable sources, such as from a server operating in a network cloud environment, and/or from a streamed unicast transmission or multicast transmission. Each advertising decision 126 may include an insertion time code 131 corresponding to each advertisement asset identifier 130 for determining at what time after the start of advertising break 161 to insert a respective advertisement 158. In some embodiments, advertising decision response 136 may include client identifier 140 and/or service identifier 142.

Continuing with the details by which a advertisement 158 is inserted at advertising client device 102, match engine 122 may be configured to insert advertisement 158 into programming stream 108 based on a match between in-band marker 148 included in programming stream 108 and advertising decision response 136. In some embodiments, match engine 122 may be configured to match an availability slot identifier 168 included in in-band marker 148 with an availability slot identifier 168 included in advertising decision response 136 and with an advertisement asset identifier 130 included in the advertising decision 126 corresponding to the advertisement 158 to be inserted. For example, a winter sports programming stream may include an in-band marker including an availability slot identifier indicating that a snowboard advertisement is to be inserted into the winter sports programming stream. Match engine 122 may match the availability slot identifier with a matching availability slot identifier included in a winter sports program advertising decision received from advertising decision server 110, and insert the snowboard advertisement into the winter sports programming stream.

Match engine 122 of advertising client device 102 may be configured to send programming stream 108, including advertisement 158, to display 104 for viewing. Thus, in the winter sports program example above, a subscriber viewing the winter sports program would be presented with the snowboard advertisement inserted into the winter sports programming stream during the advertising break. In some embodiments, advertising client device 102 may include an input-output device 112, which includes software components configured to receive and to send messages to remote devices over a network.

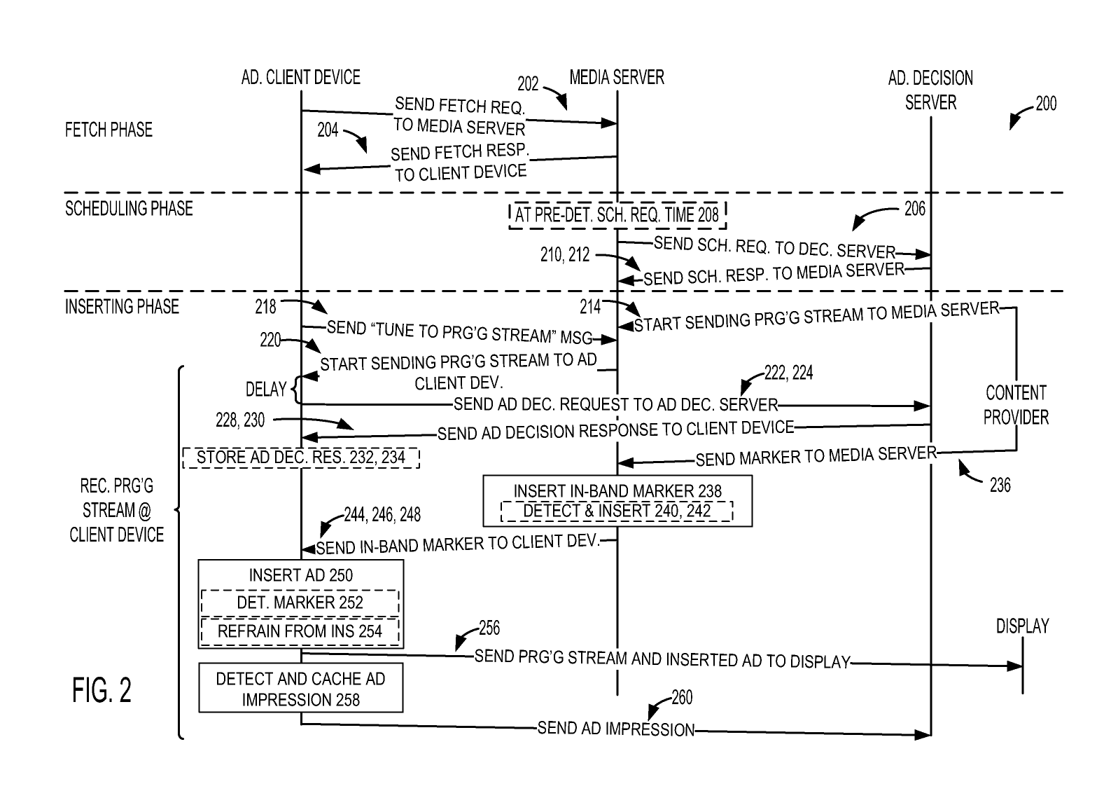

Turning now to FIG. 2, a method 200 is illustrated for insertion of an advertisement into a live video programming stream and for in-band marking of the programming stream at a media server. Method 200 may be implemented using the hardware and software components described above in relation to FIG. 1, or via other suitable hardware and software components. Thus, while FIG. 2 refers to an advertising client device, a media server, an advertising decision server, and a display of the kinds described in FIG. 1, it will be appreciated that other embodiments of method 200 may be performed on other suitable hardware. For example, in some embodiments, the advertising client device associated with the display may be selected from a group consisting of a television set top box, a digital display tuner in a separate housing from the display, a digital display tuner included in a housing for the display, a computing device in a separate housing from the display, a computing device included in a housing for the display, a mobile display device, a gaming console, and a personal computing device. Further, for clarity of explanation, FIG. 2 refers to an advertisement fetch phase for fetching advertisements. For example, in some embodiments, advertisements may be fetched from a media server, a server operating in a network cloud environment, etc., for storage at the advertising client device. FIG. 2 also refers to a scheduling phase for scheduling when advertisements may be inserted into the programming stream, and an insertion phase for inserting the advertisements into the programming stream. However, it will be appreciated that these phases are merely exemplary and other suitable phases may be utilized. Further, the order of steps in method 200 is merely exemplary, and another suitable order of steps may be utilized.

Turning now to the details of the advertisement fetch phase, method 200 may include, at step 202, receiving an advertisement fetch request at the media server for one or more advertisements from the advertising client device for storage at the advertising client device for a predetermined fetch time block. Continuing, method 200 may include, at step 204, sending an advertisement fetch response including one or more advertisements from the media server to the advertising client device.

Turning now to the details of the scheduling phase, method 200 may include, at step 206, sending an advertising schedule request from the media server to the advertising decision server for identifying a schedule of available advertising slots in a programming stream. In some embodiments, step 206 may include, at step 208, sending the advertising schedule request to the advertising decision server at a predetermined advertising schedule request time. For example, the advertising schedule request may include a request for a schedule of available advertising slots for a twenty-four hour block of time.

Continuing, method 200 may include, at step 210, receiving an advertising schedule response at the media server from the advertising decision server. In some embodiments, step 210 may include, at step 212, receiving an availability slot identifier for identifying an available advertising slot of an advertising break of the programming stream and a corresponding duration of the advertising break in the advertising schedule response.

Turning now to the details of the insertion phase, method 200 may include, at step 214, receiving the programming stream at the media server from a content provider of the programming stream. Continuing, method 200 may include, at step 218, tuning to the programming stream served by the media server at the advertising client device. Next, at step 220, method 200 may include sending the programming stream from the media server to the advertising client device.

Continuing, method 200 may include, at step 222, sending an advertising decision request for one or more available advertising slots occurring during a predetermined programming time block from the advertising client device to an advertising decision server. In some embodiments, the advertising decision request may be sent to the advertising decision server after a predetermined delay time after tuning to the programming stream. For example, sending the advertising decision request may be delayed until the subscriber has lingered at programming stream for thirty seconds.

Further, in some embodiments, step 222 may include, at step 224, sending a request for a plurality of advertising decisions for a plurality of corresponding advertising slots during the course of the predetermined programming time block from the advertising client device to the advertising decision server; sending a service identifier for identifying a content provider of the programming stream from the advertising client device to the advertising decision server; sending a timestamp corresponding to a time at which the advertising decision request is sent to the advertising decision server from the advertising client device to the advertising decision server; and sending a duration of the predetermined programming time block from the advertising client device to the advertising decision server. Thus, for example, the advertising decision request may include a request for advertising decisions for a subsequent sixty-minute time block.

Continuing, method 200 may include, at step 228, receiving an advertising decision response from the advertising decision server at the advertising client device. In some embodiments, step 228 may include, at step 230, receiving the service identifier at the advertising client device from the advertising decision server; receiving an availability slot identifier for identifying an available advertising slot at the advertising client device from the advertising decision server; receiving an advertising break structure corresponding to the availability slot identifier, the advertising break structure being configured to include an occupied slot duration for the available advertising slot at the advertising client device from the advertising decision server; receiving an advertisement asset identifier for identifying the advertisement to be inserted from one or more advertisements from the advertising decision server; and receiving an insertion time code for identifying a time after the start of the advertising slot at which to insert the advertisement at the advertising client device from the advertising decision server.

In some embodiments, step 230 may include, at step 232, storing the advertising decision response at the advertising client device according to the availability slot identifier and/or the service identifier during the predetermined programming time block for later retrieval by the advertising client device. Additionally, step 232 may include, at step 234, storing advertising decision responses for multiple service identifiers during the corresponding predetermined programming time block for each service identifier. For example, in one embodiment advertising decision responses for up to four service identifiers may be stored at advertising client device 102.

Continuing, method 200 may include, at step 236, receiving an advertising break marker for marking the start of the advertising break in the programming stream at the media server. Next, method 200 may include, at step 238, inserting an in-band marker into the programming stream. Step 238 may include, at step 240, detecting the advertising break marker; and inserting the availability slot identifier and the corresponding break duration into the programming stream upon receipt of the advertising break marker. Further, step 240 may include, at step 242, inserting a time-remaining indicator for indicating a remaining time of the break duration as a portion of the in-band marker at the media server; indexing the time-remaining indicator according to a predetermined index time at the media server; and repeating insertion of the in-band marker each time the time-remaining indicator is indexed at the media server. Thus, for example, the advertising client device may be able to avoid inserting an advertisement into an available advertising slot in a scenario where the advertisement has a duration exceeding a time remaining of the advertising break.

Continuing, method 200 may include, at step 244, sending the programming stream including the in-band marker to the advertising client device. At step 246, method 200 may include receiving the programming stream from the media server at the advertising client device, the programming stream including an in-band marker corresponding to the advertising decision response received from the advertising decision server. Step 246 may include, at step 248, receiving an availability slot identifier and a corresponding break duration included in the in-band marker from the media server at the advertising client device.

Continuing, method 200 may include, at step 250, inserting an advertisement into the programming stream after the in-band marker based on the in-band marker. Step 250 may include, at step 252, detecting the in-band marker at the advertising client device; interpreting the availability slot identifier included in the in-band marker at the advertising client device; interpreting the advertising break structure associated with the availability slot identifier at the advertising client device; selecting an advertising decision from the advertising decision response based on the availability slot identifier at the advertising client device; and inserting the advertisement into the programming stream at the insertion time code upon determining that there is no overlap between the occupied slot duration and the insertion time code of the advertising decision at the advertising client device. Thus, for example, the advertising client device may avoid inserting an advertisement in a first scenario where the inserted advertisement would overlap an underlying advertisement inserted by the content provider. Further, step 252 may include, at step 254, refraining from inserting the advertisement upon determining that there is an overlap between a portion of the advertisement and a content portion of the programming stream. Thus, for example, the advertising client device may avoid inserting an advertisement in a second scenario where the inserted advertisement would overlap underlying content.

Continuing, method 200 may include, at step 256, sending the programming stream with the advertisement to a display for viewing, and, at step 258, detecting an advertisement impression of the advertisement inserted by the advertising client device and caching the detected advertisement impression at the advertising client device. Continuing, method 200 may include, at step 260, sending the cached advertisement impression to the advertisement decision server from the advertising client device.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An advertising client device for inserting an advertisement into a live video programming stream, comprising:
a match engine executed on a processor of the advertising client device, the match engine being configured to receive a programming stream from a media server upon tuning to the programming stream, to send an advertising decision request, after a predetermined delay time after tuning to the programming stream, to an advertising decision server for one or more advertising decisions for a predetermined programming time block, to receive an advertising decision response from the advertising decision server, to insert a advertisement into the programming stream based on a match between an in-band marker included in the programming stream and the advertising decision response, and to send the programming stream including the advertisement to a display for viewing.

2. The advertising client device of claim 1, where the advertising decision response is stored at the advertising client device and where the advertising decision response includes one or more advertising decisions, wherein each advertising decision comprises a first availability slot identifier for identifying an available advertising slot and a respective advertisement asset identifier for identifying an advertisement for insertion into the programming stream.

3. The advertising client device of claim 2, where the match engine is further configured to match an availability slot identifier included in the in-band marker with a corresponding availability slot identifier included in the advertising decision response and with an advertisement asset identifier included in the advertising decision response corresponding to the advertisement to be inserted.

4. A method for insertion of an advertisement into a live video programming stream, the method comprising, at a match engine executed on an advertising client device associated with a display:
tuning to a programming stream served by a media server;
sending an advertising decision request for one or more available advertising slots occurring during a predetermined programming time block to an advertising decision server after a predetermined delay time after tuning to the programming stream;
receiving an advertising decision response from the advertising decision server;
receiving the programming stream from the media server, the programming stream including an in-band marker corresponding to the advertising decision response received from the advertising decision server;
inserting an advertisement into the programming stream after the in-band marker based on the in-band marker; and
sending the programming stream with the advertisement to a display for viewing.

5. The method of claim 4, wherein sending the advertising decision request further comprises:
sending a request for a plurality of advertising decisions for a plurality of corresponding advertising slots during the predetermined programming time block;
sending a service identifier for identifying a content provider of the programming stream;
sending a timestamp corresponding to a time at which the advertising decision request is sent to the advertising decision server; and
sending a duration of the predetermined programming time block.

6. The method of claim 4, further comprising:
detecting an advertisement impression of the advertisement inserted by the advertising client device;
caching the detected advertisement impression at the advertising client device; and
sending the cached advertisement impression to the advertisement decision server.

7. The method of claim 4, wherein receiving the advertising decision response further comprises:
receiving a service identifier for identifying a content provider of the programming stream;
receiving an availability slot identifier for identifying an available advertising slot;
receiving an advertising break structure corresponding to the availability slot identifier, the advertising break structure being configured to include an occupied slot duration for the available advertising slot;
receiving an advertisement asset identifier for identifying the advertisement to be inserted at the advertising client device; and
receiving an insertion time code for identifying a time after a start of an advertising slot at which to insert the advertisement.

8. The method of claim 7, further comprising storing the advertising decision response at the advertising client device according to the availability slot identifier and/or the service identifier during the predetermined programming time block for later retrieval by the advertising client device.

9. The method of claim 8, further comprising storing advertising decision responses for multiple service identifiers during a corresponding predetermined programming time block for each service identifier.

10. The method of claim 4, wherein receiving the programming stream from the media server further comprises receiving an availability slot identifier and a corresponding break duration included in the in-band marker.

11. The method of claim 4, wherein inserting the advertisement into the programming stream after the in-band marker based on the in-band marker further comprises:
detecting the in-band marker;
interpreting an availability slot identifier included in the in-band marker;
interpreting an advertising break structure associated with the availability slot identifier included in the advertising decision response;
selecting an advertising decision from the advertising decision response based on the availability slot identifier; and
inserting the advertisement into the programming stream at an insertion time code upon determining that there is no overlap between an occupied slot duration and the insertion time code of the advertising decision.

12. The method of claim 11, further comprising refraining from inserting the advertisement upon determining that there is an overlap between a portion of the advertisement and a content portion of the programming stream.

13. The method of claim 4, wherein the advertising client device associated with the display is selected from a group consisting of a television set top box, a digital display tuner in a separate housing from the display, a digital display tuner included in a housing for the display, a computing device in a separate housing from the display, a computing device included in a housing for the display, a mobile display device, a gaming console, and a personal computing device.

14. A method for in-band marking of a live video programming stream for insertion of an advertisement, the method comprising, at a media server:
sending an advertising schedule request to an advertising decision server for identifying a schedule of available advertising slots in a programming stream;
receiving an advertising schedule response from the advertising decision server;
receiving the programming stream from a content provider of the programming stream;
inserting an in-band marker into the programming stream; and
sending the programming stream including the in-band marker to an advertising client device.

15. The method of claim 14, further comprising:
receiving an advertisement fetch request for one or more advertisements from the advertising client device for storage at the advertising client device for a predetermined fetch time block; and
sending an advertisement fetch response including one or more advertisements to the advertising client device.

16. The method of claim 14, wherein receiving an advertising schedule response further comprises receiving an availability slot identifier for identifying an available advertising slot of an advertising break of the programming stream and a corresponding break duration of the advertising break.

17. The method of claim 14, wherein receiving the programming stream from a content provider of the programming stream further comprises receiving an advertising break marker for marking a start of an advertising break in the programming stream.

18. The method of claim 14, where inserting the in-band marker into the programming stream comprises:
detecting an advertising break marker; and
inserting an availability slot identifier and a corresponding break duration into the programming stream upon receipt of an advertising break marker.

19. The method of claim 18, further comprising:
inserting a time-remaining indicator for indicating a remaining time of a break duration as a portion of the in-band marker;
indexing the time-remaining indicator according to a predetermined index time; and
repeating insertion of the in-band marker each time the time-remaining indicator is indexed.

20. The method of claim 14, where sending the advertising schedule request includes sending the advertising schedule request to the advertising decision server at a predetermined advertising schedule request time.
